(19) United States
(12) Patent Application Publication
(10) Pub. No.: US 2026/0270544 A1
(43) Pub. Date: Sep. 10, 2026

(54) IMAGING APPARATUS

(71) Applicant: Panasonic Intellectual Property Management Co., Ltd., Osaka (JP)

(72) Inventor: Junpei MATSUDA, Osaka (JP)

(73) Assignee: Panasonic Intellectual Property Management Co., Ltd., Osaka (JP)

(21) Appl. No.: 19/555,172

(22) Filed: Mar. 3, 2026

(30) Foreign Application Priority Data
Mar. 7, 2025 (JP) 2025-036586

(51) Int. Cl. H04N 23/611; H04N 23/62; H04N 23/63

(52) U.S. Cl. CPC H04N 23/611; H04N 23/62; H04N 23/635

(57) ABSTRACT

An imaging apparatus includes an image sensor, a first recognizer, a second recognizer, and a controller. The image sensor captures a subject image to generate image data. The first recognizer recognizes a first region of a first subject in an image based on the image data, the image being indicated by the image data generated by the image sensor. The second recognizer recognizes a second region of a second subject in the image based on the image data, the second subject being included in the first subject or different from the first subject. The controller determines a subject region of a recognition result in the image data based on the first region of the first subject recognized by the first recognizer and the second region of the second subject recognized by the second recognizer.

### TECHNICAL FIELD

The present disclosure relates to an imaging apparatus that recognizes a region of a subject in an image.

### BACKGROUND ART

JP 2020-126434 A discloses an imaging apparatus that aims to appropriately select a subject intended by a user when selecting a main subject from an image. The imaging apparatus determines the main subject by a learned CNN for an image displayed in live view, and selects a dataset to be used for additional learning of the CNN in response to a user operation of changing the main subject from the determination result. From datasets including the image displayed in the live view and a region of the main subject, the dataset is selected for each of positive learning and negative learning. The positive learning is the additional learning for a region which should be determined as the main subject. The negative learning is the additional learning for a region which should not be determined as the main subject. The imaging apparatus of JP 2020-126434 A performs the additional learning when the number of images in the selected dataset is a threshold value or more.

### SUMMARY

The present disclosure provides an imaging apparatus capable of easily recognizing a region of a subject according to a user’s intention in an image.

An imaging apparatus according to one aspect of the present disclosure includes an image sensor, a first recognizer, a second recognizer, and a controller. The image sensor captures a subject image to generate image data. The first recognizer recognizes a first region of a first subject in an image based on the image data, the image being indicated by the image data generated by the image sensor. The second recognizer recognizes a second region of a second subject in the image based on the image data, the second subject being included in the first subject or different from the first subject. The controller determines a subject region of a recognition result in the image data based on the first region of the first subject recognized by the first recognizer and the second region of the second subject recognized by the second recognizer.

An imaging apparatus according to another aspect of the present disclosure includes an image sensor, a user interface, and a controller. The image sensor captures a subject image to generate image data. The user interface receives a user operation. The controller controls image recognition processing on a first subject on the image data generated by the image sensor in response to the user operation received via the user interface. The controller receives the user operation setting a second subject included in the first subject or different from the first subject via the user interface, and controls the image recognition processing based on the second subject set via the user interface to determine the subject region of the recognition result in the image data.

The imaging apparatus according to the present disclosure can easily recognize a region of a subject according to a user’s intention in an image.

### BRIEF DESCRIPTION OF THE DRAWINGS

FIG. 1 is a diagram illustrating a configuration of a digital camera according to a first embodiment of the present disclosure;

FIG. 2 is a diagram for describing an outline of an operation of the digital camera;

FIG. 3 is a flowchart illustrating filtering setting processing in the digital camera;

FIGS. 4A to 4D are diagrams each illustrating a display example of a filtering setting screen displayed in the digital camera of the first embodiment;

FIG. 5 is a flowchart illustrating subject recognition processing in the digital camera of the first embodiment;

FIGS. 6A to 6D are diagrams for describing the subject recognition processing in the digital camera of the first embodiment;

FIG. 7 is a flowchart illustrating subject filtering processing in the subject recognition processing;

FIG. 8 is a flowchart illustrating exclusion determination processing in the subject filtering processing;

FIGS. 9A to 9C are diagrams for describing the exclusion determination processing;

FIG. 10 is a flowchart illustrating narrowing determination processing in the subject filtering processing;

FIGS. 11A to 11C are diagrams for describing the narrowing determination processing;

FIGS. 12A and 12B are diagrams for describing an operation of a digital camera according to the second embodiment;

FIG. 13 is a flowchart illustrating subject recognition processing in the digital camera of the second embodiment; and

FIGS. 14A to 14C are diagrams for describing subject filtering processing in the digital camera of the second embodiment.

### DETAILED DESCRIPTION

Hereinafter, embodiments will be described in detail with reference to the drawings as appropriate. However, detailed descriptions more than necessary will be omitted in some cases. For example, detailed descriptions of already well-known matters and duplicate descriptions for substantially the same configuration will be omitted in some cases. A reason thereof is to avoid unnecessary redundancy of the following description and to facilitate the understanding of those skilled in the art. The inventor(s) provides the accompanying drawings and the following description in order for those skilled in the art to fully understand the present disclosure, and does not intend to limit the subject described in the claims by these.

### First Embodiment

In a first embodiment, a digital camera that recognizes a region of a subject in a captured image will be described as an example of an imaging apparatus according to the present disclosure.

### 1. Configuration

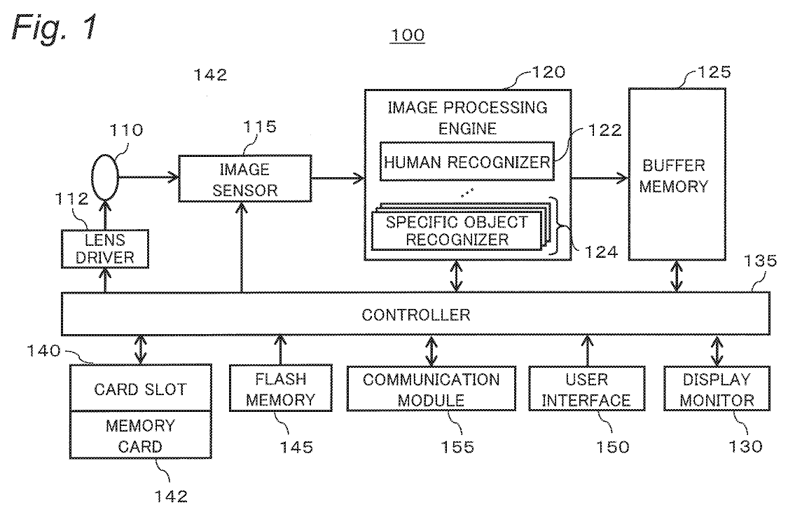

FIG. 1 is a diagram illustrating a configuration of a digital camera 100 according to the present embodiment. The digital camera 100 of the present embodiment includes an image sensor 115, an image processing engine 120, a display monitor 130, and a controller 135. Further, the digital camera 100 includes a buffer memory 125, a card slot 140, a flash memory 145, a user interface 150, and a communication module 155. In addition, the digital camera 100 includes, for example, an optical system 110 and a lens driver 112.

The optical system 110 includes a focus lens, a zoom lens, an optical image stabilization lens (OIS), an aperture, a shutter, and the like. The focus lens is a lens configured to change a focus state of a subject image formed on the image sensor 115. The zoom lens is a lens configured to change magnification of the subject image formed by the optical system. Each of the focus lens and the like is configured using one or more lenses.

The lens driver 112 drives the focus lens and the like in the optical system 110. The lens driver 112 includes a motor to move the focus lens along an optical axis of the optical system 110 under the control of the controller 135. A configuration for driving the focus lens in the lens driver 112 can be realized by a DC motor, a stepping motor, a servo motor, an ultrasonic motor, or the like.

The image sensor 115 captures the subject image formed via the optical system 110 and generates captured data. The captured data constitutes image data indicating an image captured by the image sensor 115. The image sensor 115 generates image data of a new frame at a predetermined frame rate (e.g., 30 frames/second). The generation timing of captured data and an electronic shutter operation of the image sensor 115 are controlled by the controller 135. As the image sensor 115, various image sensors, such as a CMOS image sensor, a CCD image sensor, and an NMOS image sensor, can be used.

The image sensor 115 performs an operation of capturing a still image and an operation of capturing a through image, and the like. The through image is mainly a moving image, and is displayed on the display monitor 130 so that a user determines a composition to capture a still image, for example. The image sensor 115 is an example of an imager in the present embodiment.

The image processing engine 120 performs various types of processing on the captured data output from the image sensor 115 to generate image data, or performs various types of processing on image data to generate an image to be displayed on the display monitor 130. Examples of the various types of processing include white balance correction, gamma correction, YC conversion processing, electronic zoom processing, compression processing, decompression processing, and the like, but are not limited thereto. The image processing engine 120 may be configured using a hard-wired electronic circuit, or may be configured using a microcomputer, a processor, or the like using a program.

The image processing engine 120 in the present embodiment includes a human recognizer 122 and a plurality of specific object recognizers 124 that detect regions corresponding to subjects, such as a person and an object, as recognition targets in a captured image by an image recognition technique on the basis of image data indicating the captured image. Each specific object recognizer 124 performs detection processing by image recognition of such a subject region for a specific type of subject. In the digital camera 100 of the present embodiment, for example, the specific object recognizer 124 corresponding to the selected subject is used for detecting the subject region together with the human recognizer 122 in response to a user operation selecting the type of the subject by the user interface 150.

Each of the recognizers 122 and 124 is configured as a trained model by machine learning of various deep neural networks (DNNs) such as CNN, for example. The human recognizer 122 is trained to detect a region corresponding to a person in an image. Each specific object recognizer 124 is trained to detect a region corresponding to a specific type of object in an image. For example, the human recognizer 122 and the specific object recognizer 124 output a position and a size of the detected region on the image as detection results of a person region and a specific object region, respectively.

The trained model of the human recognizer 122 is generated by supervised learning, for example, on the basis of training data in which each of a plurality of images and a region corresponding to the entire body of a person in each image are associated with each other. Similarly to the human recognizer 122, for example, the trained model of each specific object recognizer 124 is generated on the basis of training data in which each of a plurality of images is associated with a region corresponding to a specific type of object in each image. The recognition target of the specific object recognizer 124 is not limited to a subject different from the recognition target of the human recognizer 122, and may be a subject included in the recognition target of the human recognizer 122, such as a person of a specific type.

The trained model of each of the recognizers 122 and 124 is not limited to the DNN described above, and may be a machine learning model for various types of image recognition. Each of the recognizers 122 and 124 is not limited to the machine learning model, and may detect the region of the subject by, for example, a rule-based image recognition technique such as template matching. The human recognizer 122 and the specific object recognizers 124 are examples of a first recognizer and a second recognizer in the present embodiment, respectively.

The display monitor 130 is an example of a display that displays various types of information. For example, the display monitor 130 displays an image (through image) indicated by image data which is captured by the image sensor 115 and subjected to image processing by the image processing engine 120. In addition, the display monitor 130 displays a menu screen or the like for a user to make various settings for the digital camera 100. The display monitor 130 can be configured using, a liquid crystal display device or an organic EL device, for example.

The user interface 150 is a general term for at least one operation interface such as an operation button and an operation dial provided on the exterior of the digital camera 100 to receive a user operation. The user interface 150 includes, a release button, a mode dial, a touch panel on the display monitor 130, a joystick, and the like, for example. When receiving the user operation, the user interface 150 transmits an operation signal corresponding to the user operation to the controller 135. The user interface 150 may be various GUIs such as virtual buttons, icons, cursors, software keyboards, and/or objects displayed on the display monitor 130.

The controller 135 is a hardware controller and controls the operation of the entire digital camera 100 overall. The controller 135 includes a CPU and the like, and the CPU realizes a predetermined function by executing a program (software). The controller 135 may, in place of the CPU, include a processor configured using a dedicated electronic circuit designed to realize a predetermined function. That is, the controller 135 can be implemented with various processors such as a CPU, an MPU, a GPU, a DSU, an FPGA, and an ASIC. The controller 135 may be configured by using one or more processors. In addition, the controller 135 may be configured using one semiconductor chip together with the image processing engine 120 and the like.

The buffer memory 125 is a recording medium that functions as a work memory for the image processing engine 120 and the controller 135. The buffer memory 125 is realized by a dynamic random access memory (DRAM) or the like. The flash memory 145 is a non-volatile recording medium.

Although not illustrated, the controller 135 may have various internal memories, and include a built-in ROM, for example. Various programs executed by the controller 135 are stored in the ROM. In addition, the controller 135 may include a RAM that functions as a work area of the CPU.

The card slot 140 is a means for inserting a removable memory card 142. The card slot 140 enables electrical and mechanical connection with the memory card 142. The memory card 142 is an external memory having a recording element such as a flash memory inside. The memory card 142 can store data such as image data generated by the image processing engine 120.

The communication module 155 is a communication module (circuit) that performs communication according to the communication standard IEEE 802.11, Wi-Fi standard or the like. The digital camera 100 can communicate with another device via the communication module 155. The digital camera 100 may directly communicate with another device via the communication module 155, or may communicate via an access point. The communication module 155 may be connectable to a communication network such as the Internet. The communication module 155 is an example of a communication interface in the present embodiment.

### 2. Operation

An operation of the digital camera 100 configured as described above will be described.

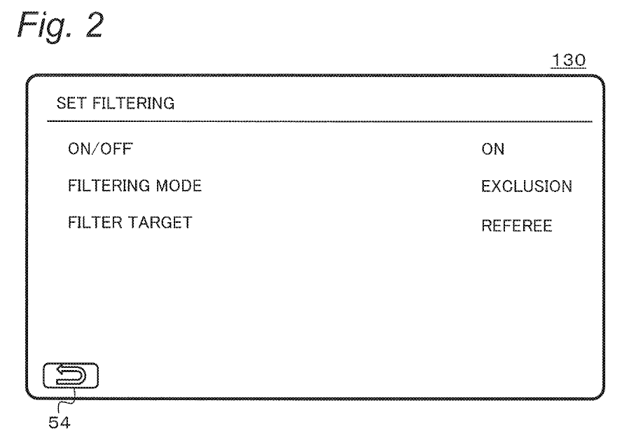

The digital camera 100 of the present embodiment determines a region to be used for autofocus (AF) control, for example, on the basis of detection results from the two types of recognizers 122 and 124 in processing of recognizing a region of a subject in a captured image. As the subject region of a recognition result by such subject recognition processing, the digital camera 100 of the present embodiment extracts a part of the person region, such as one or more regions among detected regions, from the detection result of the person region by the human recognizer 122 in the captured image, referring to the detection result of the specific object region by the specific object recognizer 124. An outline of such filtering operation in the subject recognition processing of the digital camera 100 will be described with reference to FIG. 2.

FIG. 2 illustrates an example of filtering setting in the digital camera 100 of the present embodiment. The digital camera 100 of the present embodiment can set filtering in response to a user operation on the menu screen displayed on the display monitor 130 as illustrated in FIG. 2, for example. In the example of FIG. 2, a function of performing the filtering in the digital camera 100 is turned on, that is, set to be enabled, and furthermore, a filtering condition corresponding to each menu item of a “filtering mode” and a “filter target” is set. The filtering condition indicates, for example, a condition such as a method of extracting a person region and the recognition target of the specific object recognizer 124 used for filtering.

The digital camera 100 of the present embodiment determines a person region of the recognition result of the subject recognition processing in accordance with a filtering mode set as an operation mode of the filtering, for example. In the example of FIG. 2, an exclusion mode for excluding the person region from the recognition result for a specific subject is set. In the exclusion mode, for example, the digital camera 100 excludes the person region from the recognition result for the subject of the type set as a filter target.

In the example of FIG. 2, in a photographing scene of a sports game, the filter target is set to a referee on an assumption that the user wants to focus on a player by AF control but does not want to focus on the referee. In this case, the specific object recognizer 124 that detects a region corresponding to the referee in the image is used. After such setting, the digital camera 100 can determine the person region of the recognition result by, for example, filtering to exclude the person region corresponding to the region of the referee detected by the specific object recognizer 124 in the captured image from the detection result by the human recognizer 122. Hereinafter, details of the operation of the digital camera 100 in the present embodiment will be described.

### 2-1. Filtering Setting Processing

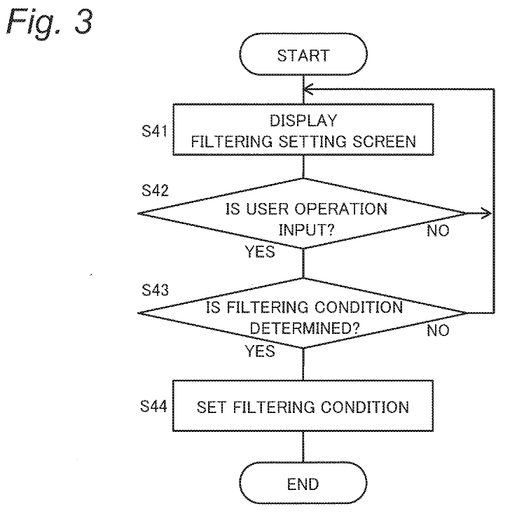

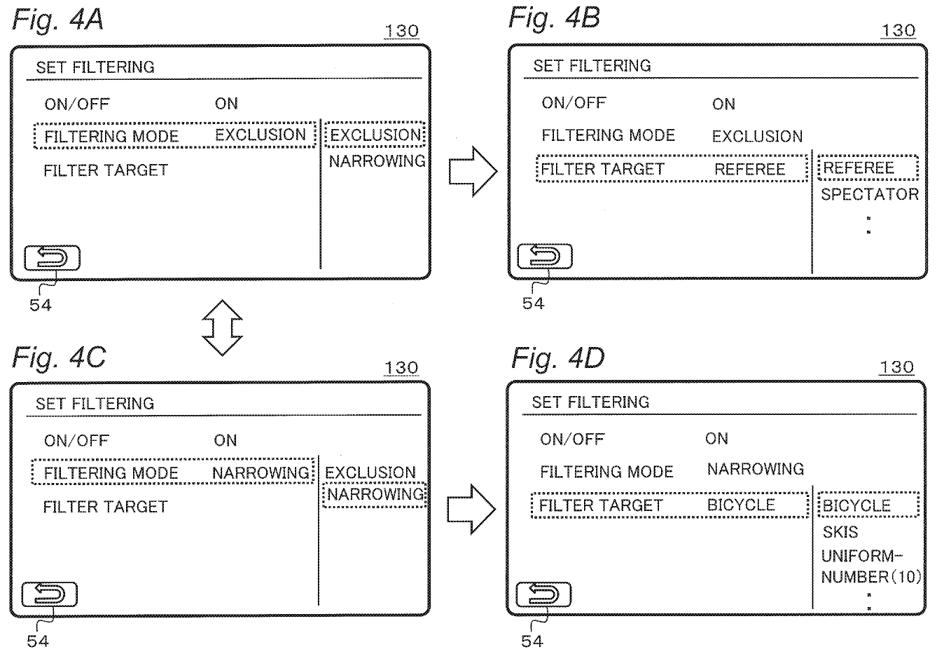

The digital camera 100 of the present embodiment performs setting on the filtering in the subject recognition processing in response to a user operation on the menu screen as illustrated in FIG. 2. Such filtering setting processing in the digital camera 100 will be described with reference to FIGS. 3 and 4A to 4D.

FIG. 3 is a flowchart illustrating the filtering setting processing in the digital camera 100. The processing illustrated in FIG. 3 is started in response to a user operation on a predetermined menu screen for setting the digital camera 100, for example.

First, a controller 135 of the digital camera 100 causes the display monitor 130 to display a filtering setting screen as the menu screen for performing setting on the filtering (S41).

FIGS. 4A to 4D are diagrams each illustrating a display example of the filtering setting screen in the digital camera 100 of the present embodiment. FIGS. 4A and 4B illustrate transition of the filtering setting screen when the filtering condition as illustrated in a setting example of FIG. 2 is set. The filtering setting screen of this example includes “ON/OFF”, “filtering mode”, and “filter target” as the menu items selectable by the user, and a return button 54, and also includes a return button 54. Selecting “ON/OFF” causes the digital camera 100 to display options for switching enabling or disabling of the filtering in the subject recognition processing in response to, for example, a selection operation by the user. The return button 54 receives a user operation of returning a screen transition on the display monitor 130 of the digital camera 100 by one screen.

The controller 135 determines whether a user operation on the filtering setting screen is input via the user interface 150 (S42). In a case where no user operation is input (NO in S42), the controller 135 repeats the processing in step S41 and subsequent steps.

In a case where a user operation is input (YES in S42), the controller 135 determines whether the filtering condition is determined by the user operation (S43). For example, when a user operation of the return button 54 on the filtering setting screen is input, the controller 135 determines that the filtering condition is determined (YES in S43).

In a case where the filtering condition is not determined (NO in S43), the controller 135 repeats the processing in step S41 and subsequent steps. FIG. 4A illustrates a display example in a case where a user operation on the filtering setting screen is input (YES in S42) and the menu item “filtering mode” is selected. The controller 135 causes the filtering setting screen to display options of the filtering mode in the digital camera 100 in response to the user operation (NO in S43, S41). In the digital camera 100 of the present embodiment, for example, a narrowing mode can be used in addition to the exclusion mode as the filtering mode.

FIG. 4B illustrates an example in which the exclusion mode is selected in the example of FIG. 4A and a user operation selecting the menu item “filter target” is input in step S42. In response to the user operation, for example, as illustrated in FIG. 4B, the controller 135 causes the filtering setting screen to display options of the type of subject selectable as the filter target in the exclusion mode (NO in S43, S41). For example, in the digital camera 100, the options of the filter target are displayed corresponding to the recognition targets of the specific object recognizer 124 available in each filtering mode.

FIG. 4C illustrates an example in which the filtering mode is changed to the narrowing mode in the example of FIG. 4A. The narrowing mode is a filtering mode in which the recognition result by the subject recognition processing is narrowed down to a specific person region on the basis of the detection result by each of the recognizers 122 and 124. From the example of FIG. 4C, FIG. 4D illustrates an example in which the options of the filter target in the narrowing mode are displayed on the filtering setting screen in response to the user operation in step S42. For example, the filter target of the narrowing mode is set as a subject of which a corresponding specific object region is used for narrowing.

When the filtering condition is determined in response to the user operation on the filtering setting screen (YES in S43), the controller 135 sets the filtering condition in the subject recognition processing (S44). For example, the controller 135 generates setting information including the filtering condition determined in addition to whether the filtering is enabled or disabled, and holds the setting information in the buffer memory 125. Thereafter, the controller 135 ends the processing of this flowchart.

In the filtering setting processing described above, the filtering condition in the subject recognition processing is set in response to the user operation (S41 to S44). As a result, the recognition result can be filtered in the subject recognition processing on the basis of the set filtering condition.

The filtering setting processing and the filtering setting screen are not limited to the above example. For example, in response to the user operation in step S42, the filtering setting screen may transition to another screen displaying options of the filtering conditions in step S41. On such a setting screen, text or the like indicating various types of information such as description of each option may be displayed. The determination in step S43 is not limited to the above example. For example, a completion button for receiving a user operation for completing the setting of the filtering condition may be provided on the filtering setting screen, and the determination of the filtering condition may be determined in response to the user operation of pressing the completion button.

### 2-2. Subject Recognition Processing

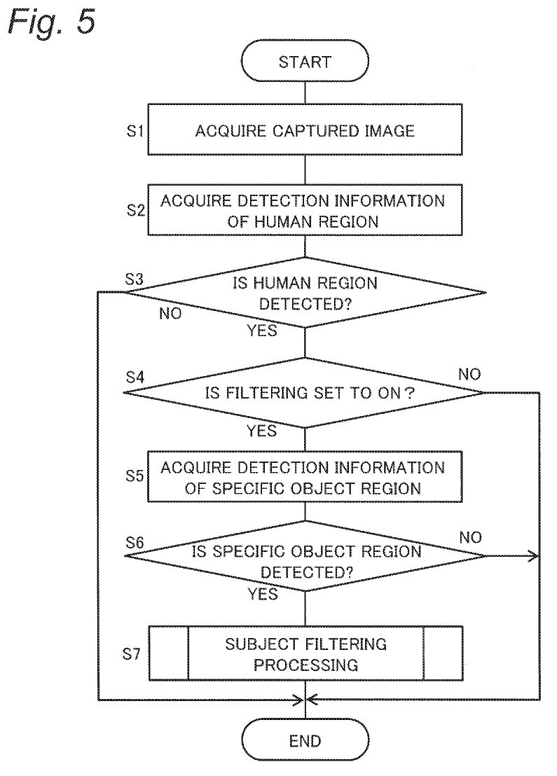

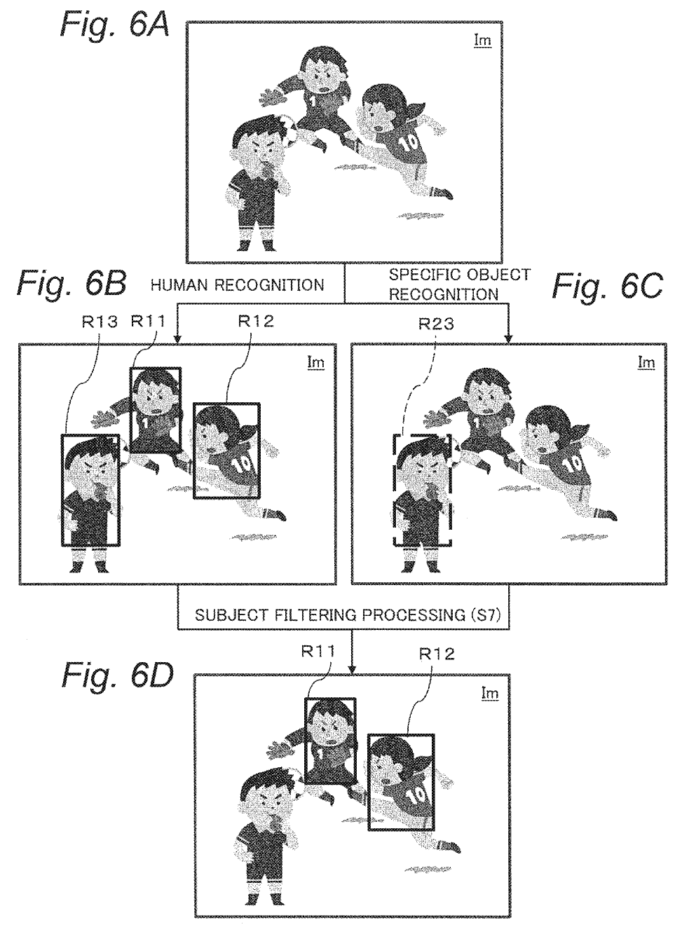

The subject recognition processing using the filtering conditions set as described above in the digital camera 100 of the present embodiment will be described with reference to FIGS. 5 and 6A to 6D.

FIG. 5 is a flowchart illustrating the subject recognition processing in the digital camera 100 of the present embodiment. The processing illustrated in FIG. 5 is started in a state where setting information such as the filtering condition set by the filtering setting processing is held in the buffer memory 125. The processing of FIG. 5 is performed in a predetermined cycle such as a frame cycle with the image sensor 115 performing an imaging operation of various moving images such as the through image.

First, the controller 135 of the digital camera 100 acquires the captured image generated by the imaging operation from the image sensor 115 (S1). Such a captured image Im is illustrated in FIG. 6A. FIGS. 6A to 6D are diagrams for describing the subject recognition processing in the digital camera 100 of the present embodiment. Hereinafter, an example will be described in which the filtering condition illustrated in FIG. 2 is set on the assumption of a photographing scene in a sports game as illustrated in the captured image Im of FIG. 6A.

The controller 135 causes the human recognizer 122 to perform detection processing on the acquired captured image Im, and acquires detection information indicating a detection result of the person region (S2). FIG. 6B illustrates person regions R11 to R13 detected in the captured image Im in FIG. 6A. In this example, the person regions R11 and R12 corresponding to two players and the person region R13 corresponding to one referee are detected.

The controller 135 determines whether a person region is detected in the captured image Im on the basis of the detection information acquired from the human recognizer 122 (S3). In a case where the person region is not detected (NO in S3), the controller 135 ends the processing of this flowchart, and performs the processing in step S1 and subsequent steps again for the next frame, for example, with the imaging operation being performed.

In a case where the person region is detected (YES in S3), the controller 135 determines whether the filtering is enabled, that is, whether the filtering is set to ON by referring to the setting information held in the buffer memory 125 (S4).

In a case where the filtering is turned on (YES in S4), the controller 135 causes, for example, the specific object recognizer 124 corresponding to the filter target in the filtering condition of the setting information to perform the detection processing on the captured image Im acquired in step S1 (S5). By performing such detection processing, the controller 135 of the present embodiment acquires detection information of the specific object region detected by the specific object recognizer 124 in the captured image Im (S5). In this example, the referee set as the filter target in the filtering condition of FIG. 2 is set to the specific subject, and the specific object recognizer 124 that detects a corresponding region is used. FIG. 6C illustrates a specific object region R23 detected in the captured image Im in FIG. 6A.

The controller 135 determines whether a specific object region is detected in the captured image Im on the basis of the detection information acquired from the specific object recognizer 124 (S6).

In a case where the specific object region is detected (YES in S6), the controller 135 determines a person region as a recognition result by the subject recognition processing in the captured image Im, on the basis of the detection information of the person region and the specific object region acquired in steps S2 and S5, respectively (S7). In step S7, the controller 135 determines a recognition result, for example, by filtering a plurality of detected person regions in accordance with the detection result of the specific object region. FIG. 6D illustrates an example in which the person regions R11 and R12 are determined as the recognition result in the captured image Im from the person regions R11 to R13 and the specific object region R23 illustrated in FIGS. 6B and 6C by such subject filtering processing (S7).

In the example of FIG. 6D, the person region R13 corresponding to the specific object region R23 is excluded from the person regions R11 to R13. In step S7, the controller 135 determines whether each of the person regions R11 to R13 corresponds to the specific object region R23 on the basis of the detection information by each of the recognizers 122 and 124, for example, and determines the person region R13 as an exclusion target. The exclusion target is determined as a person region corresponding to the subject as the filter target of the exclusion mode in the captured image Im, for example. After performing the subject filtering processing (S7), the controller 135 ends the processing of this flowchart. Details of the subject filtering processing (S7) will be described later.

On the other hand, in a case where the specific object region is not detected (NO in S6), the controller 135 ends the processing of this flowchart without performing the subject filtering processing (S7). In a case where the filtering is turned off (NO in S4), the controller 135 ends the processing of the flowchart without performing the processing (S5 to S7) related to the filtering such as referring to the specific object region. In these cases, the controller 135 may determine the recognition result on the basis of the detection information of the person region before filtering. For example, the detection information of the person region acquired in step S2 may be used as a recognition result of the subject recognition processing for the frame in which the captured image Im is acquired in step S1.

In the subject recognition processing as described above, the subject filtering processing is performed in accordance with the filtering setting (S4) on the basis of the detection information by the human recognizer 122 and the specific object recognizer 124 (S2 to S3, S5 to S6, and S7). For example, some person regions R11 and R12 are extracted from the person regions R11 to R13 detected in the captured images Im illustrated in FIGS. 6A to 6D by referring to the specific object region R23 in accordance with the set filtering condition, and are determined as the recognition result (S7). In this manner, for example, in addition to the human recognizer 122, the recognition result can be determined by using the specific object recognizer 124 for the specific type of person set as the filter target, and the recognition result of the subject according to the user’s intention can be easily obtained.

In the digital camera 100, the subject recognition processing is not limited to the above example, and may be performed only in a case where the filtering is turned on, for example. In this case, whether the filtering is enabled or disabled is not required to be determined in step S4.

### 2-2-1. Subject Filtering Processing

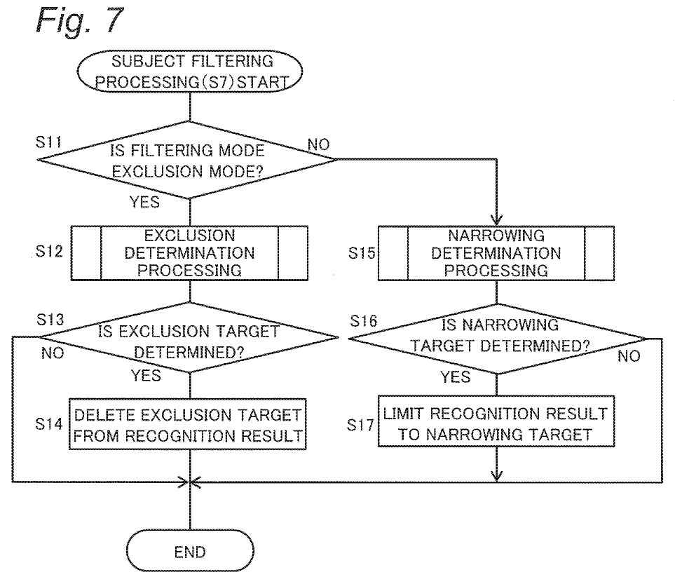

Details of the subject filtering processing in step S7 of FIG. 5 will be described with reference to FIG. 7.

FIG. 7 is a flowchart illustrating the subject filtering processing (S7) in the subject recognition processing (FIG. 5). The processing of this flowchart is started in a state where the detection information by the human recognizer 122 and the specific object recognizer 124 acquired in steps S2 and S5 of FIG. 5 is held in the buffer memory 125 in addition to the setting information such as the filtering condition.

The controller 135 of the digital camera 100 determines whether the filtering mode is set to the exclusion mode with reference to, for example, the setting information (S11).

In a case where the filtering mode is the exclusion mode (YES in S 11), the controller 135 determines whether each person region corresponds to the subject as the filter target in the exclusion mode on the basis of the detection information by each of the recognizers 122 and 124 (S12). For example, the controller 135 determines the exclusion target by comparing the position and the size of each detected person region on the captured image Im with the position and the size of the detected specific object region in accordance with the setting of the filter target in the exclusion mode. Details of such exclusion determination processing (S12) will be described later.

Next, the controller 135 determines whether the exclusion target is determined in the exclusion determination processing (S12) (S13).

In a case where the exclusion target is determined (YES in S13), the controller 135 deletes the person region determined as the exclusion target from an unfiltered recognition result such as all the person regions detected in the captured image Im, and determines the filtered recognition result (S14). Thereafter, the controller 135 ends the processing of this flowchart, and repeats the processing of step S1 and subsequent steps in FIG. 5 on the captured image Im of the next frame, for example.

In a case where the exclusion target is not determined (NO in S13), the controller 135 ends the processing of this flowchart without performing the processing of step S14.

In a case where the filtering mode is not set to the exclusion mode but to the narrowing mode (NO in S13), the controller 135 determines whether each person region is a narrowing target on the basis of the detection information by each of the recognizers 122 and 124 (S15). The narrowing target is determined as a person region corresponding to the subject as the filter target of the narrowing mode in the captured image Im, for example. In step S15, the controller 135 determines the narrowing target, for example, by comparing positions on an image between each detected person region and the specific object region. Processing of such narrowing determination processing (S15) will be described later.

The controller 135 determines whether the narrowing target is determined in the narrowing determination processing (S15) (S16).

In a case where the narrowing target is determined (YES in S16), the controller 135 limits the person region included in the recognition result in the detection information by the human recognizer 122 to the person region as the narrowing target (S17). After determining the recognition result filtered by such narrowing (S17), the controller 135 ends the processing of this flowchart.

In a case where no narrowing target is determined (NO in S16), the controller 135 ends the processing of this flowchart without performing the processing of step S17. In a case where the exclusion target or the narrowing target is not determined (NO in S13 or NO in S16) and the processing of steps S14 and S17 is not performed, for example, the detection information of all the person regions in the captured image Im may be used as the recognition result.

In the subject filtering processing (S7) as described above, the exclusion determination processing (S12) or the narrowing determination processing (S15) is performed in accordance with the set filtering mode (S11), and the recognition result by the subject recognition processing is determined (S14 and S17). For example, a recognition result excluding the exclusion target from all the person regions detected by the human recognizer 122 is determined in accordance with the result of the exclusion determination processing (S12 to S14). Furthermore, a recognition result limited to the narrowing target is determined in accordance with the result of the narrowing determination processing (S15 to S17). In this manner, by determining the recognition result in accordance with the setting of the filter target in each filtering mode, the recognition result of the subject can be easily obtained in accordance with the user’s intention.

### (1) Exclusion Determination Processing

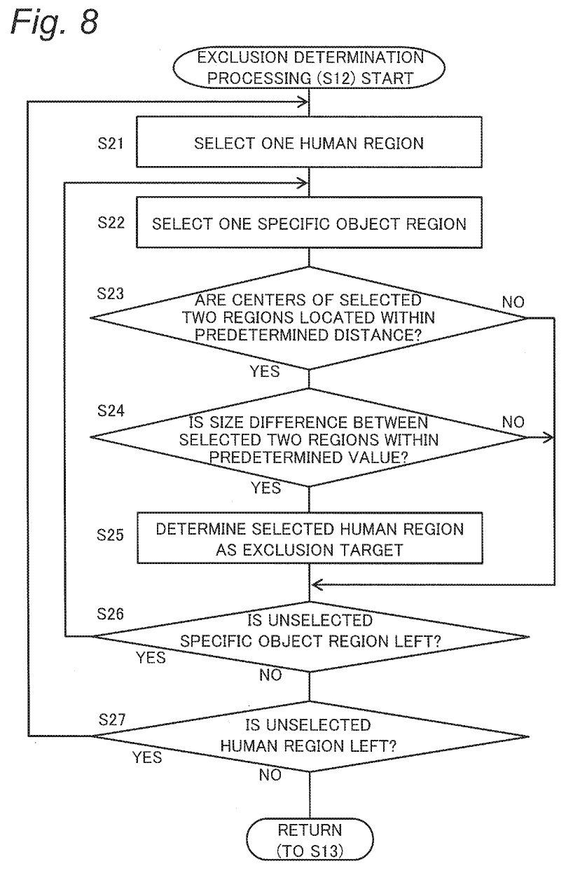

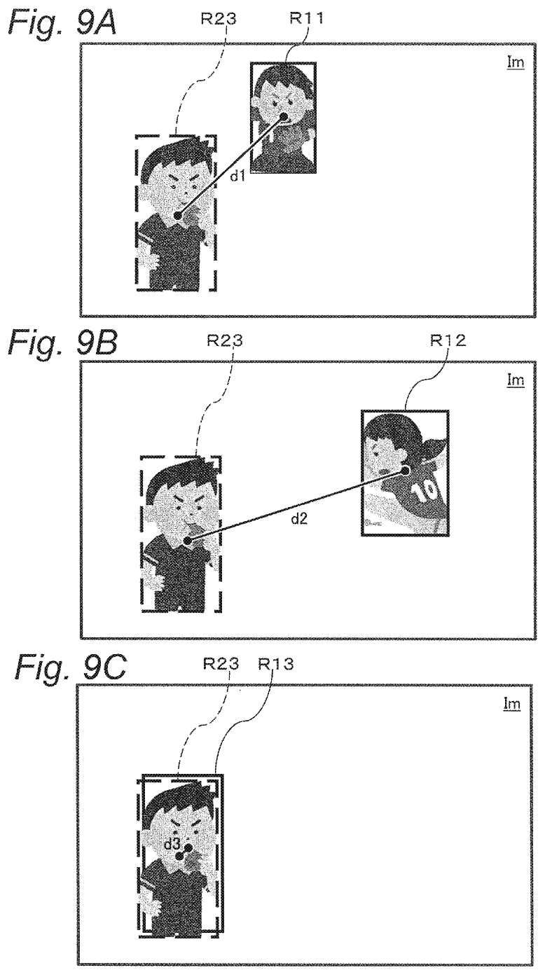

Details of the exclusion determination processing in step S12 of FIG. 7 will be described with reference to FIGS. 8 and 9A to 9C.

FIG. 8 is a flowchart illustrating the exclusion determination processing (S12) in the subject filtering processing (S7 in FIGS. 7 and 5). FIGS. 9A to 9C are diagrams for describing the exclusion determination processing (S12). Hereinafter, an example in which the exclusion determination processing (S12) is performed on the basis of the detection information of the person region and the specific object region in a captured image Im similar to the captured image illustrated in FIG. 6A will be described.

The controller 135 selects one person region from the detection information by the human recognizer 122 held in the buffer memory 125, for example (S21). FIG. 9A is an explanatory diagram illustrating a state in which the person region R11 is selected from the person regions R11 to R13 detected similarly to the example in FIG. 6B.

Furthermore, the controller 135 also selects one specific object region from the detection information by the specific object recognizer 124 (S22). In this example, the specific object region R23 similar to the specific object region illustrated in FIG. 6C is selected.

The controller 135 determines, for the person region and the specific object region selected in steps S21 and S22, whether the centers of the respective regions in the captured image Im are located within a predetermined distance (S23). For example, in the state of FIG. 9A, it is determined whether a distance d1 between center positions in each of the regions R11 and R23 is within a predetermined distance. The predetermined distance is defined by, for example, a ratio with respect to the size of the person region in the captured image Im, and is set to a value (e.g., 3% of a diagonal length of the person region) small enough to consider that the person region and the specific object region correspond to the same subject.

In a case where the distance between the center positions in the selected two regions is within the predetermined distance (YES in S23), the controller 135 determines whether the difference between the sizes of the two regions in the captured image Im is within a predetermined value (S24). The predetermined value of the difference between the sizes is defined by, for example, a ratio of the sizes with reference to one of the regions. For each rectangular region in the captured image Im, the width and height of the region each as the predetermined value are set to values (e.g., 5% of the width or height of the person region) that are small enough to be considered to correspond to the same subject.

On the other hand, in a case where the distance between the center positions in the selected two regions is not within the predetermined distance (NO in S23), the controller 135 proceeds to step S26. In step S26, the controller 135 determines whether another specific object region not selected in step S22 is included in the detection information by the specific object recognizer 124. In a case where the difference between the sizes of the selected two regions is not within the predetermined value (NO in S24), the controller 135 also proceeds to the determination in step S26.

In a case where another specific object region is included in the detection information (YES in S26), the controller 135 selects a next specific object region in the detection information (S22), and repeats the subsequent processing. Whether each specific object region is selected may be managed by, for example, a predetermined flag, and the flag may be reset when the processing proceeds to the next step S27.

In a case where another specific object region is not included in the detection information obtained by the specific object recognizer 124 (NO in S26), the controller 135 determines whether another person region not selected in step S21 is included in the detection information obtained by the human recognizer 122 (S27). For example, in the state of FIG. 9A, when the distance d1 is not within the predetermined distance (NO in S23) and another specific object region is not included in the detection information (NO in S26), the determination in step S27 is performed.

In a case where another person region is included in the detection information (YES in S27), the controller 135 selects the next person region in the detection information (S21), and repeats the subsequent processing. FIG. 9B illustrates a state in which the next person region R12 is selected from the state of FIG. 9A and the specific object region R23 is selected in step S22. FIG. 9C illustrates a state in which the next person region R13 is selected instead of the person region R12 from the state of FIG. 9B, for example, based on a distance d2 between the regions R12 and R23 is not within the predetermined distance (NO in S23).

In a case where the distance between the selected person region and specific object region is within the predetermined distance (YES in S23) and the difference between the sizes of the two regions is within the predetermined value (YES in S24), the controller 135 determines the person region as the exclusion target (S25). For example, in the state of FIG. 9C, the person region R13 is determined as the exclusion target based on a distance d3 between the person region R13 and the specific object region R23 is within the predetermined distance (YES in S23) and the difference between the sizes of the two regions R13 and R23 is within the predetermined value (YES in S24).

After determining the exclusion target (S25), the controller 135 repeats the subsequent processing in accordance with the determination in step S26. Comparison in step S23 and the like is performed for all the person regions and the specific object region in the detection information, and when another person region is not included (NO in S27), the controller 135 ends the processing of this flowchart. Thereafter, the controller 135 returns to the next processing (S13 in FIG. 7) in the subject filtering processing (S7).

In the exclusion determination processing (S12), an exclusion target is determined from the person regions detected in the captured image Im, in accordance with the comparison of the position and size between each person region and each specific object region (S23 and S24) (S25). For example, as illustrated in FIGS. 6A to 6D and 9A to 9C, from the detection information on the person regions R11 to R13, the person region R13 is determined as the exclusion target based on that the person region R13 has the position and the size that can be regarded as corresponding to the same subject as the specific object region R23. In this manner, in the exclusion determination processing (S12), the exclusion target can be determined by simple calculation processing, and the processing load on the digital camera 100 can be reduced, for example.

Furthermore, for example, without constructing a new data set of a machine learning model or performing additional learning as in JP 2020-126434 A, the recognition result intended by the user is easily obtained by determining the recognition result excluding the exclusion target (S14 in FIG. 7).

### (2) Narrowing Determination Processing

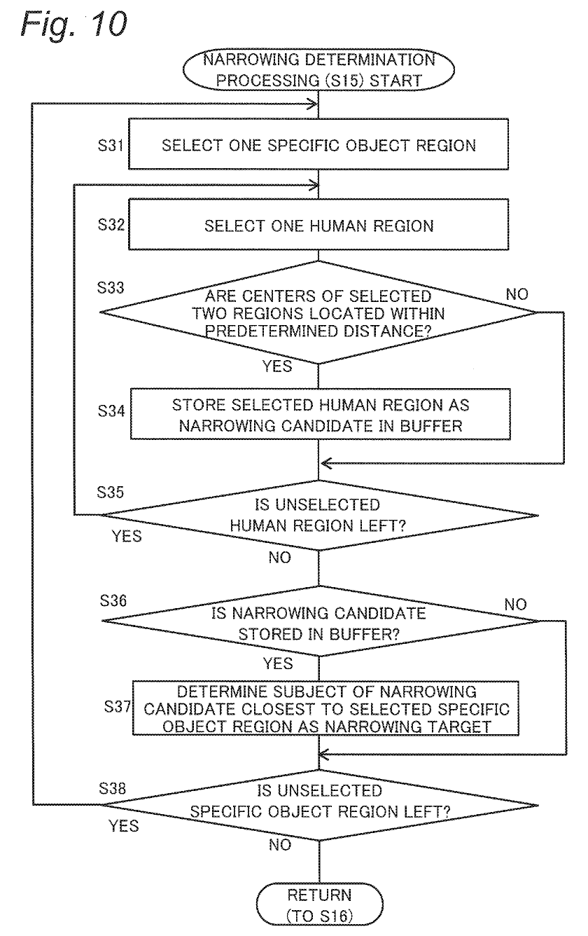

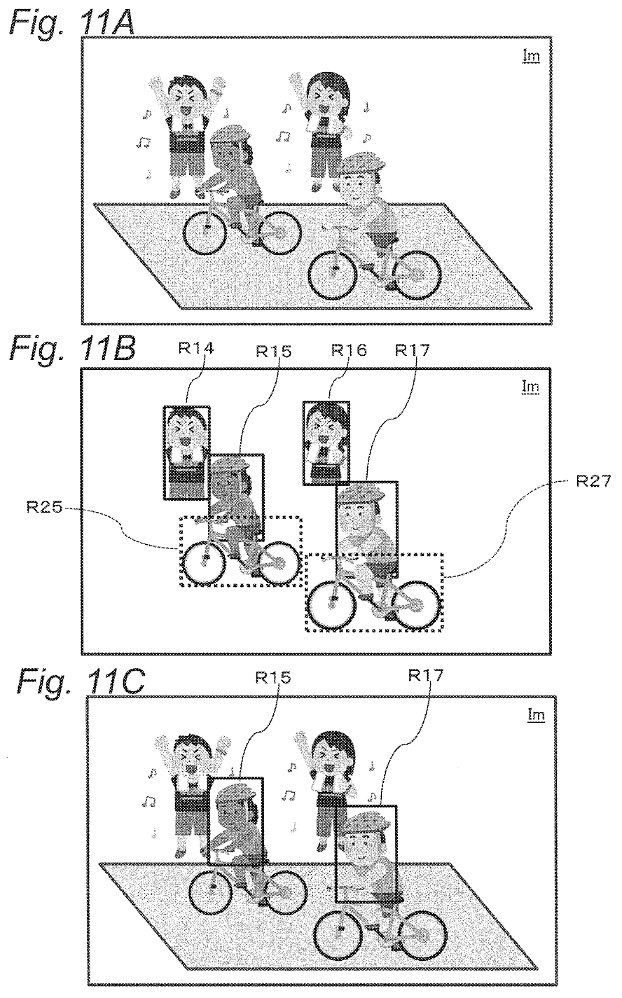

Next, details of the narrowing determination processing in step S15 of FIG. 7 will be described with reference to FIGS. 10 and 11A to 11C.

FIG. 10 is a flowchart illustrating the narrowing determination processing (S15) in the subject filtering processing (S7 and FIG. 7). FIGS. 11A to 11C are diagrams for describing the narrowing determination processing (S15). As an illustration, a case will be described where the filtering mode is set to the narrowing mode and the filtering target is set to “bicycle” on the filtering setting screen illustrated in FIGS. 4C and 4D by the filtering setting processing (FIG. 3). In the subject recognition processing of this example, in addition to the human recognizer 122, the specific object recognizer 124 that recognizes a bicycle as a recognition target as a subject related to a person is used.

FIG. 11A illustrates the captured image Im in a scene different from the scene of FIG. 6A. FIG. 11B illustrates person regions R14 to R17 detected by the human recognizer 122 in the captured image Im of FIG. 11A, and specific object regions R25 and R27 detected by the specific object recognizer 124. In this example, the person regions R14 and R16 of the spectators and the person regions R15 and R17 of the players on bicycles are detected. FIG. 11C illustrates an example in which the recognition result is determined by the narrowing determination processing (S15) in the captured image Im of FIG. 11A.

In the example illustrated in FIGS. 11A to 11C, the person regions R14 to R17 to R15 and R17 are determined as the narrowing target by the filtering condition set on an assumption that the player and the bicycle correspond to each other on a one-to-one basis, and the recognition result is limited to the narrowing target.

Hereinafter, an example will be described in which the narrowing determination processing (S15) illustrated in FIG. 10 is performed on the captured image Im of FIG. 11A in a state where the detection information of the person regions R14 to R17 and the detection information of the specific object regions R25 and R27 illustrated in FIG. 11B are acquired (S2 and S5 in FIG. 5).

For example, the controller 135 selects one specific object region from the detection information by the specific object recognizer 124 (S31), and further selects one person region from the detection information by the human recognizer 122 (S32).

The controller 135 determines, for the person region and the specific object region selected in steps S31 and S32, whether the centers of the respective regions in the captured image Im are located within a predetermined distance (S33). The predetermined distance of the narrowing determination processing may be set to a value (e.g., 50% of the diagonal length of the person region) larger than the predetermined distance in step S23 of the exclusion determination processing, for example, from a viewpoint of specifying a person region located near a specific object region in the captured image Im. In step S33, the controller 135 may calculate the distance between the center positions of the two regions on the basis of the detection information, for example, and hold the calculation result in association with the two regions.

In a case where the distance between the center positions of the two selected regions is within the predetermined distance (YES in S33), the controller 135 sets the selected person region as a candidate for determination of the narrowing target, and stores detection information of the person region in, for example, a predetermined buffer region (S34). The buffer region of such a narrowing candidate may be provided in the buffer memory 125, for example.

After buffering the narrowing candidate (S34), the controller 135 determines whether another person region is included in the detection information as in step S27 of the exclusion determination processing (S35). In a case where the distance between the selected two regions is not within the predetermined distance (NO in S33), the controller 135 proceeds to the determination in step S35 without performing the processing in step S34.

In a case where another person region is included in the detection information (YES in S35), the controller 135 selects the next person region (S32) and repeats the subsequent processing.

In a case where another person region is not included in the detection information (NO in S35), the controller 135 determines whether the narrowing candidate is stored in the buffer region (S36). For example, when the specific object region R25 illustrated in FIG. 11B is selected (S31), the distance to the specific object region R25 is compared for each of the person regions R14 to R17, and the candidates for the narrowing target are buffered in accordance with the comparison result (S32 to S35).

In a case where the narrowing candidates are stored in the buffer region (YES in S36), the controller 135 determines, as the narrowing target, a candidate closest to the selected specific object region in the captured image Im among the stored candidates (S37). Such a closest candidate can be determined, for example, on the basis of the distance between the two regions calculated in step S33. For example, for the specific object region R25 of FIG. 11B, in a case where the person regions R14 and R15 are the narrowing candidates, the person region R15 closer to the specific object region R25 is determined as the narrowing target.

The controller 135 determines the narrowing target from the person regions as the narrowing candidates for the selected specific object region (S37), and then determines whether another specific object region is included in the detection information (S38). When the narrowing candidate is not stored in the buffer region (YES in S36), the controller 135 proceeds to the determination in step S38 without performing the processing in step S37.

In a case where another specific object region is included in the detection information (YES in S38), the controller 135 selects the next specific object region (S31) and repeats the subsequent processing.

In a case where another specific object region is not included in the detection information (NO in S38), the controller 135 ends the processing of this flowchart, and returns to the next processing (S16 in FIG. 7) in the subject filtering processing (S7).

In the narrowing determination processing (S15) described above, the narrowing target is determined, from the person regions detected in the captured image Im, in accordance with the comparison of the positions between each person region and each specific object region (S31 to S38). For example, in the captured images Im illustrated in FIGS. 11A to 11C, the person regions R15 and R17, which are respectively closest to the specific object regions R25 and R27, are determined as the narrowing targets from the detection information of the person regions R14 to R17. In this manner, the narrowing target can be determined by simple calculation processing, and the recognition result of the subject recognition processing can be narrowed down to the person region as the narrowing target in accordance with the setting of the filtering condition.

In the above description, an example is described in which each specific object region is compared with each person region every time the specific object region is selected (S31 to S33, S35, and S38). The execution order of each processing is not limited to the above example. For example, every time a person region is selected, a narrowing candidate may be buffered in comparison with respective specific object regions, and a person region closest to each specific object region may be determined as the narrowing target after all the person regions in the detection information are compared with all the specific object regions. Further, for example, for each specific object region, two or more person regions may be determined as the narrowing target from the narrowing candidates in accordance with the distance to the specific object region in the captured image.

### 3. Summary

As described above, the digital camera 100 of the present embodiment includes the image sensor 115, the human recognizer 122 as an example of a first recognizer, the specific object recognizer 124 as an example of a second recognizer, and the controller 135. The image sensor 115 captures a subject image to generate image data. The human recognizer 122 detects a person region as an example of recognizing a first region of a first subject in the captured image based on the image data, the captured image being an example of an image indicated by the image data generated by the image sensor 115. The specific object recognizer 124 detects a specific object region as an example of recognizing a second region of a second subject included in the first subject or different from the first subject in the captured image based on the image data. Based on the person region detected by the human recognizer 122 and the specific object region detected by the specific object recognizer 124 (see S2 and S5), the controller 135 determines a person region as an example of a subject region of a recognition result in the image data (S7).

In the digital camera 100 described above, the person region as the subject region of the recognition result is determined by using the human recognizer 122 and the specific object recognizer 124 for the recognition target included in that of the human recognizer 122 or for another recognition target (S7). In this way, for example, the recognition result can be determined in accordance with the relationship between the recognition targets by the two recognizers 122 and 124, and the region of the subject according to the user’s intention can be easily recognized in the image. For example, the AF control and the like can be accurately performed on the subject intended by the user by using the subject region of such a recognition result.

In the present embodiment, the controller 135, extracts one or more person regions as an example of a partial region from detected person regions as an example of the person region detected by the human recognizer 122 in the captured image, referring to the specific object region detected by the specific object recognizer 124, and determines the extracted partial region as the person region of the recognition result (S7 and FIG. 7). For example, as illustrated in FIGS. 6A to 6D and 11A to 11C, a person region corresponding to a specific object region is excluded from one or more detected person regions (S14), or the detected person regions are narrowed down to a person region related to a specific object region (S17), and the extracted specific person region can be determined as the recognition result.

In the present embodiment, for example, the filter target as an example of the second subject in the exclusion mode is a specific type of subject included in the person as an example of the first subject. For example, in the captured image Im as illustrated in FIG. 6, the controller 135 excludes, from the person regions R11 to R13 detected by the human recognizer 122, the person region R13 having a predetermined correspondence relationship with the specific object region R23 detected by the specific object recognizer 124 , and determines the person regions R11 and R12 remained after exclusion as the person regions of the recognition result (S14). In the present embodiment, in a case where the center positions of the person region and the specific object region are within the predetermined distance (YES in S23) and the difference between the sizes is within a predetermined value (YES in S24) in the captured image Im, it is determined that the two regions have the predetermined correspondence relationship. In such filtering processing in the exclusion mode (S7 and S12 to S14), for example, a specific subject can be excluded from the recognition result by simple calculation processing by using the detection results by the two recognizers 122 and 124.

In the present embodiment, for example, the filter target as an example of the second subject in the narrowing mode is a different subject related to a person as an example of the first subject. For example, in the captured images Im as illustrated in FIGS. 11A to 11C, the controller 135 narrows the person regions R14 to R17 detected by the human recognizer 122 to person regions located within a predetermined range from the specific object regions R25 and R27 detected by the specific object recognizer 124, and determines the person regions R15 and R17 narrowed down as the person regions of the recognition result (S7 and S15 to S17). In the present embodiment, in a case where the center positions of two regions are within the predetermined distance (YES in S33), it is determined that the two regions are located within the predetermined range. In such filtering processing in the narrowing mode (S7 and S15 to S17), for example, the recognition result can be narrowed down to a part of subjects by simple calculation processing by using the detection result by the two recognizers 122 and 124.

In the present embodiment, the digital camera 100 further includes the user interface 150 that receives a user operation. The controller 135 receives a user operation setting the filter target as an example of the second subject via the user interface 150 (S42, see FIGS. 4A and 4B), and causes the specific object recognizer 124 to detect a specific object region set as the filter target (see S5). In this way, for example, the recognition target of the specific object recognizer 124 is set as the filter target in response to the user operation, and the region of the subject according to the user’s intention can be more easily recognized by the filtering processing (S7) using the specific object recognizer 124.

In the present embodiment, the controller 135 determines the person region of the recognition result on the basis of the person region detected by the human recognizer 122 without referring to the specific object region in a case where the filter target is not set, in such a case where the filtering is turned off (NO in S4), and determines the person region of the recognition result on the basis of both the person region detected by the human recognizer 122 and the specific object region recognized by the specific object recognizer 124 in a case where the filter target is set, in such a case where the filtering is turned on (YES in S4) (S5 to S7). In this manner, for example, the person region determined as the recognition result changes in accordance with the filtering setting, and the recognition result according to the setting by the user operation can be used in the digital camera 100.

In the present embodiment, the digital camera 100 includes the image sensor 115 as an example of an imager that captures a subject image to generate image data, the user interface 150 that receives a user operation, and the controller 135 In response to a user operation received via the user interface 150 (S42 to S44), the controller 135 controls subject recognition processing for a person as an example of the image recognition processing for the first subject on the image data generated by the image sensor 115 (S1 to S7). The controller 135 receives the user operation setting the filter target as an example of a second subject included in the first subject or different from the first subject via the user interface 150 (S42), to control the subject recognition processing on the basis of the filter target set via the user interface 150 to determine a person region as an example of the subject region of the recognition result in the image data (S7).

In the above digital camera 100, it is possible to control the subject recognition processing in accordance with the setting of the filter target by the user operation, and to easily recognize the region of the subject according to the user’s intention.

### Second Embodiment

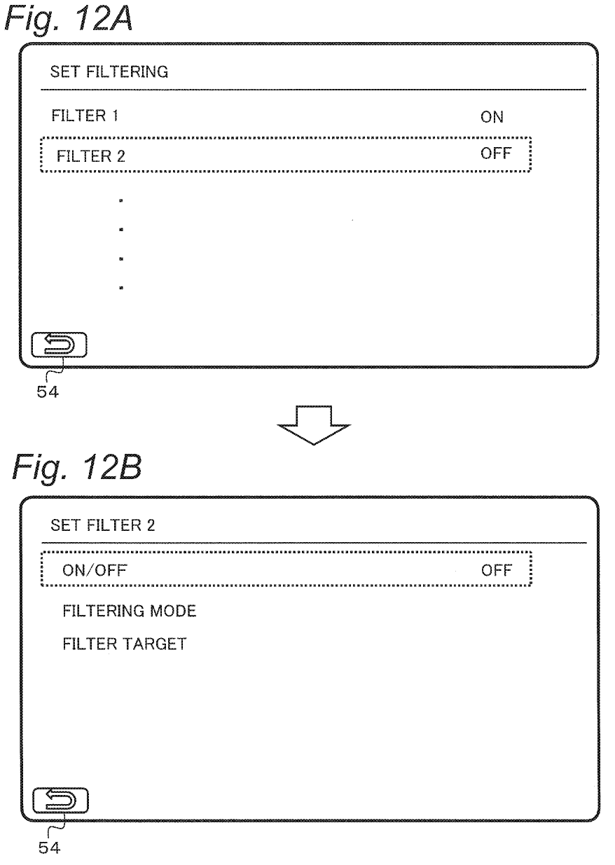

Hereinafter, a second embodiment of the present disclosure will be described with reference to FIGS. 12A to 14C. The first embodiment describes the digital camera 100 that determines the recognition result in the captured image by using one specific object recognizer 124 in addition to the human recognizer 122 in the subject recognition processing. In the second embodiment, the digital camera 100 that determines a recognition result by using a plurality of specific object recognizers 124 in combination will be described.

Hereinafter, the digital camera according to the present embodiment will be described by omitting the description of the configurations and operations similar to those of the digital camera 100 according to the first embodiment as appropriate.

### 1. Filtering Setting

FIGS. 12A and 12B are diagrams for describing the operation of the digital camera 100 according to the second embodiment. The digital camera 100 of the present embodiment sets the filtering conditions for each of the plurality of specific object recognizers 124 used in combination. In the filtering setting processing of the present embodiment, the controller 135 of the digital camera 100 first causes the display monitor 130 to display a screen as illustrated in FIG. 12A as the filtering setting screen, for example (S41 in FIG. 3).

On the filtering setting screen illustrated in FIG. 12A, options such as “filter 1” and “filter 2” for setting the filtering conditions for the plurality of specific object recognizers 124 are displayed. In the example of FIG. 12A, for each option, whether the filtering is enabled or disabled by setting the option is displayed by “ON” or “OFF”. The controller 135 causes, in response to a user operation selecting the one option the display monitor 130 to display a screen for setting the filtering condition for a selected option, for example (S41 to S43). FIG. 12B illustrates a filtering setting screen that transitions in accordance with selection of “filter 2” from the screen in FIG. 12A.

In the digital camera 100 of the present embodiment, for example, each filtering condition can be set on a filtering setting screen similar to the filtering setting screens in FIGS. 4A to 4D, as illustrated in FIG. 12B. For example, the controller 135 determines that the filtering condition is determined in response to the user operation on the screen illustrated in FIG. 12A (YES in S43), and sets the filtering condition in the subject recognition processing (S44). In this manner, in the present embodiment, the filtering condition using the plurality of specific object recognizers 124 can be set.

### 2. Subject Recognition Processing

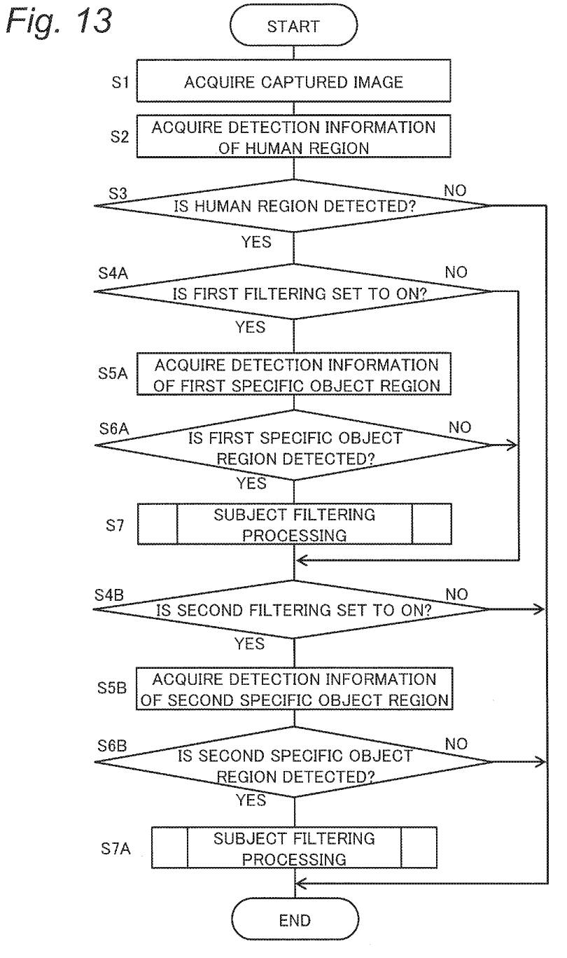

FIG. 13 is a flowchart illustrating the subject recognition processing in the digital camera 100 of the second embodiment. Hereinafter, for example, an example will be described in which the filtering conditions by the two specific object recognizers 124 are set on the filtering setting screens as illustrated in FIGS. 12A and 12B and are held in the setting information as the filtering conditions for the first filtering and the second filtering.

For example, the digital camera 100 of the present embodiment performs the processing illustrated in the flowchart of FIG. 13 instead of the flowchart of FIG. 5 with the imaging operation similarly to the first embodiment being executed.

For example, similarly to the first embodiment, the controller 135 acquires a captured image Im (S1), acquires the detection information of the person region in the captured image Im (S2), and then determines whether the person region is detected in the captured image Im on the basis of the detection information (S3).

In the digital camera 100 of the present embodiment, in a case where the person region is detected (YES in S3), the controller 135 determines whether the first filtering setting is turned on (S4A) instead of step S4 for one filtering setting in the first embodiment, for example.

In a case where the first filtering setting is turned on (YES in S4A), the controller 135 causes the specific object recognizer 124 corresponding to the filter target of the first filtering to perform the detection processing in the captured image Im (S5A), for example, instead of step S5 in the first embodiment. In step S5A, the controller 135 acquires the detection information of such a first specific object region output from the specific object recognizer 124 of the first filtering.

The controller 135 determines whether the first specific object region is detected in the captured image Im on the basis of the detection information acquired in step S5A (S6A). In a case where the first specific object region is detected (YES in S6A), the controller 135 performs the subject filtering processing similarly to the first embodiment on the basis of, for example, the detection information of the person region acquired in step S1 and the detection information of the first specific object region acquired in step S5A (S7).

After performing the subject filtering processing (S7) based on the detection information of the person region and the first specific object region, the controller 135 of the present embodiment further determines whether the setting of the second filtering is turned on (S4B).

In a case where the second filtering setting is turned on (YES in S4B), the controller 135 causes the specific object recognizer 124 corresponding to the filter target of the second filtering to perform the detection processing in the captured image Im (S5B), for example, instead of the first filtering of step S5A. The controller 135 acquires the detection information of such a second specific object region from the specific object recognizer 124 of the second filtering (S5B).

The controller 135 determines whether the second specific object region is detected in the captured image Im on the basis of the detection information acquired in step S5B (S6B).

In a case where the second specific object region is detected (YES in S6B), the controller 135 of the present embodiment further performs the subject filtering processing (S7A). In step S7A, the controller 135 performs the subject filtering processing on the basis of the processing result in step S7 and the detection information of the second specific object region, instead of the detection information of the person region and the detection information of the first specific object region in step S7.

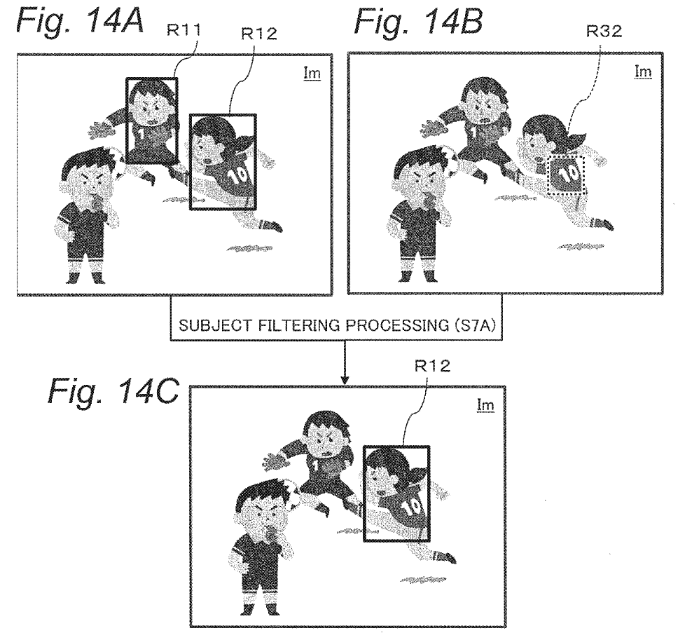

FIGS. 14A to 14C are diagrams for describing subject filtering processing (S7A) in the digital camera of the second embodiment. FIG. 14A illustrates a result of excluding the person region R11 corresponding to the first specific object region R23 as illustrated in FIG. 6C, from the person regions R11 to R13 in FIG. 6B by the subject filtering processing in step S7 in the captured image Im similar to the example of FIGS. 6A to 6D. Hereinafter, an example will be described in which, in the setting of the second filtering, the filtering mode is set to the narrowing mode, and the filtering target is set to a uniform number “10” as illustrated in FIG. 4D. In the second filtering of this example, the specific object recognizer 124 that detects the corresponding region with the uniform number “10” set as the filter target as the specific subject is used.

FIG. 14B illustrates a second specific object region R32 detected in the captured image Im of this example. For example, in step S5B, the controller 135 acquires the detection information of such a second specific object region R32. In the subject filtering processing (S7A) of this example, the controller 135 determines the narrowing target from the person regions R12 and R13 of FIG. 14A by the narrowing determination processing (S15) as illustrated in FIG. 10 (S37). In this example, among the person regions R12 and R13, the person region R12 closest to the specific object region R32 on the captured image Im is determined as the narrowing target. FIG. 14C illustrates a recognition result determined by such subject filtering processing (S7A).

As described above, in the subject recognition processing, the digital camera 100 of the present embodiment determines the recognition result in the captured image Im by two-stage subject filtering processing (S7 and S7A) using the two specific object recognizers 124. By combining the filtering conditions using the plurality of specific object recognizers 124 in this manner, it is possible to more easily recognize the region of the subject in accordance with the user’s intention. The combination of filtering conditions is not limited to the example of FIGS. 14A to 14C. For example, in a photographing scene of a ball game, two specific object recognizers 124 for a referee and a ball respectively as the recognition target may be used, and in the filtering processing, after excluding the person region corresponding to the referee, the recognition result may be narrowed down to the person region appearing near the ball.

The combination of filtering conditions is not limited to the combination of exclusion and narrowing, and may be two-stage exclusion or two-stage narrowing. Furthermore, for example, as the filtering mode, in addition to the exclusion mode and the narrowing mode, an addition mode in which a person combined with a specific object such as a “player holding a ball” can be specified as the filter target may be provided. In this case, in the addition mode, for example, a person region appearing near the ball may be determined as a recognition result by processing similar to the narrowing determination processing by using the specific object recognizer 124 that recognizes the ball as a recognition target.

In the above description, an example is described in which the digital camera 100 performs two-stage subject filtering processing by the two specific object recognizers 124. In the digital camera 100 of the present embodiment, the subject filtering processing may be performed in stages by three or more specific object recognizers 124. For example, from the above example, the recognition result may be determined by further performing subject filtering processing on the basis of the processing result of step S7A and the detection information by the third specific object recognizer 124.

### (Other Embodiments)

As described above, the first and second embodiments are described as examples of the technique disclosed in the present application. However, the technique of the present disclosure is not limited thereto, and is also applicable to embodiments obtained by appropriately performing changes, replacements, additions, omissions, and the like. It is also possible to combine the constituent elements described in each of the embodiments to form a new embodiment.

In each of the above embodiments, the digital camera 100 having both the exclusion mode and the narrowing mode as the filtering mode is described. The digital camera 100 of the present embodiment may have only one of the narrowing mode or the exclusion mode as the filtering mode.

In each of the above embodiments, an example is described in which the image processing engine 120 includes the human recognizer 122 and the plurality of specific object recognizers 124. In the digital camera 100, each of the recognizers 122 and 124 may be configured separately from the image processing engine 120. Furthermore, the digital camera 100 of the present embodiment may include only one specific object recognizer 124.

In each of the above embodiments, an example is described in which the digital camera 100 includes the trained model that functions as the human recognizer 122 and the specific object recognizer 124. In the present embodiment, the digital camera 100 is not required to include such a trained model in advance. In the present embodiment, for example, the trained model functioning as each of the recognizers 122 and 124 may be stored in an information processing apparatus such as a cloud server capable of data communication with the digital camera 100. The digital camera 100 of the present embodiment may acquire the trained model from such an external information processing apparatus via the communication module 155, for example, and cause the acquired trained model to function as the human recognizer 122 and/or the specific object recognizer 124.

For example, in the above embodiment, the digital camera 100 may further implement at least one function of the human recognizer 122 and the specific object recognizer 124 by cooperation with the external information processing apparatus as described above. For example, the digital camera 100 of the present embodiment may transmit image data of a captured image to the information processing apparatus via the communication module 155 and cause the information processing apparatus to detect the person region and/or the specific object region in the captured image. The controller 135 may acquire the detection information by the human recognizer 122 and/or the specific object recognizer 124 by causing the human recognizer 122 and/or the specific object recognizer 124 to acquire the region recognized by the information processing apparatus. In this case, the digital camera 100 is not required to include a trained model that implements the function of each of the recognizers 122 and 124 in advance, and is not required to acquire the model from the external information processing apparatus.

As described above, in the present embodiment, the digital camera 100 further includes the communication module 155 as an example of a communication interface that performs data communication with an external information processing apparatus. In the present embodiment, the controller 135 causes, via the communication module 155, the information processing apparatus to recognize a region of a subject in the image indicated by the image data, and causes at least one of the human recognizer 122 as an example of the first recognizer and the specific object recognizer 124 as an example of the second recognizer to acquire the recognized region. In this way, processing load of the image recognition processing in the digital camera 100 can be further reduced.

In each of the above embodiments, the human recognizer 122 detecting the person region is described as an example of the first recognizer in the subject recognition processing, but the subject as a recognition target by the first recognizer is not limited to a person. In the digital camera 100 of the present embodiment, for example, for a specific type of animal such as a dog or a horse in an image, the first recognizer that recognizes a region corresponding to the entire body of the animal may be used. Furthermore, the subject as a recognition target may be a specific type of insect, plant, vehicle, or the like. In the present embodiment, the specific object recognizer 124 that recognizes the specific object region in accordance with such a recognition target by the first recognizer may be used as the second recognizer.

For example, in a photographing scene where a horse race or a car race is shot, a region of a horse or an automobile is recognized by the first recognizer, and a specific number or the like is recognized by the second recognizer, so that the recognition result may be narrowed down to a horse or an automobile to which the specific number is assigned. Furthermore, the digital camera 100 of the present embodiment may have a function of recognizing pupils by image recognition. For example, in a case where the subject is a person, an animal, or the like, the pupil may be recognized from a peripheral region of the region recognized by the first recognizer in the captured image, and AF control may be performed so as to focus on the region of the pupil in the recognized region.

In each of the above embodiments, the digital camera 100 using the recognition result of the subject recognition processing for the AF control is described. In the present embodiment, the digital camera 100 may perform white balance (WB) control and/or automatic exposure (AE) on the basis of the recognition result without being limited to the AF control.

In each of the above embodiments, the digital camera 100 that determines the subject of the recognition result by the subject recognition processing for the captured image Im such as the through image is described. The digital camera 100 of the present embodiment may perform the subject recognition processing on an image indicated by image data stored in the memory card 142.

The digital camera 100 including the optical system 110 and the lens driver 112 is exemplified in each of the above embodiments. The imaging apparatus of the present embodiment do not necessarily include the optical system 110 and the lens driver 112, and may be an interchangeable lens camera, for example.

Although the digital camera is described as an example of the imaging apparatus in each of the above embodiments, the imaging apparatus is not limited thereto. The imaging apparatus of the present disclosure may be an electronic device (e.g., a video camera, a smartphone, a tablet terminal, or the like) having an image shooting function.

### Aspect Examples

Hereinafter, various aspects of the present disclosure will be exemplified.

A first aspect according to the present disclosure is an imaging apparatus comprising: an image sensor that captures a subject image to generate image data; a first recognizer that recognizes a first region of a first subject in an image based on the image data, the image being indicated by the image data generated by the image sensor; a second recognizer that recognizes a second region of a second subject in the image based on the image data, the second subject being included in the first subject or different from the first subject; and a controller that determines a subject region of a recognition result in the image data based on the first region of the first subject recognized by the first recognizer and the second region of the second subject recognized by the second recognizer.

A second aspect is the imaging apparatus according to the first aspect, wherein the controller extracts a partial region from the first region of the first subject recognized by the first recognizer in the image, referring to the second region of the second subject recognized by the second recognizer, and determines the extracted partial region as the subject region.

In the second aspect, the controller may extract a particular region from one or more first regions of the first subject recognized by the first recognizer, referring to the region of the second subject recognized by the second recognizer in the image, and determines the extracted particular region as the subject region.

A third aspect is the imaging apparatus according to the second aspect, wherein the second subject is a specific type of subject included in the first subject, and the controller excludes, from the first region of the first subject recognized by the first recognizer in the image, another partial region having a predetermined correspondence relationship with the second region of the second subject recognized by the second recognizer, and determines the extracted partial region remained after exclusion as the subject region.

A fourth aspect is the imaging apparatus according to the second aspect, wherein the second subject is a different subject related to the first subject, and the controller narrows the first region of the first subject recognized by the first recognizer to the partial region located within a predetermined range from the second region of the second subject recognized by the second recognizer in the image, and determines the extracted partial region narrowed down as the subject region.

A fifth aspect is the imaging apparatus according to any one of the first to fourth aspects, further comprising a user interface that receives a user operation, wherein the controller receives the user operation setting the second subject via the user interface, and causes the second recognizer to recognize the second region of the set second subject.

A sixth aspect is the imaging apparatus according to the fifth aspect, wherein the controller determines the subject region based on the first region of the first subject recognized by the first recognizer without referring to the second region of the second subject when the second subject is not set, and determines the subject region based on both the first region of the first subject recognized by the first recognizer and the second region of the second subject recognized by the second recognizer when the second subject is set.

A seventh aspect is the imaging apparatus according to any one of the first to sixth aspects, further comprising a communication interface that performs data communication with an external information processing device, wherein the controller causes, via the communication interface, the external information processing device to recognize a region of a subject in the image indicated by the image data, and causes at least one of the first recognizer or the second recognizer to acquire the recognized region of the subject.

An eighth aspect according to the present disclosure is an imaging apparatus comprising: an image sensor that captures a subject image to generate image data; a user interface that receives a user operation; a controller that controls image recognition processing for a first subject on the image data generated by the image sensor in response to the user operation received via the user interface, the controller receives the user operation setting a second subject included in the first subject or different from the first subject via the user interface; and controls the image recognition processing based on the second subject set via the user interface to determine a subject region of a recognition result in the image data.

As described above, the above-described embodiments are described as examples of techniques in the present disclosure. To this extent, the attached drawings and detailed descriptions are provided.

Therefore, components described in the attached drawings and the detailed description include not only components indispensable to solve the problem, but may also include components not necessarily indispensable to solve the problem in order to provide examples of the techniques. Therefore, those components not necessarily indispensable should not be deemed essential due to the mere fact that those components not necessarily indispensable are described in the attached drawings and the detailed description.

Since the above-described embodiments are given as the examples of the techniques according to the present disclosure, various modifications, replacements, additions, omissions, or the like can be made within the scope of the claims or in a scope equivalent to the scope of the claims.

The present disclosure is applicable to an imaging apparatus that recognizes a region of a subject in an image.

What is claimed is:

1. An imaging apparatus comprising:
an image sensor that captures a subject image to generate image data;
a first recognizer that recognizes a first region of a first subject in an image based on the image data, the image being indicated by the image data generated by the image sensor;
a second recognizer that recognizes a second region of a second subject in the image based on the image data, the second subject being included in the first subject or different from the first subject; and
a controller that determines a subject region of a recognition result in the image data based on the first region of the first subject recognized by the first recognizer and the second region of the second subject recognized by the second recognizer.

2. The imaging apparatus according to claim 1, wherein
the controller extracts a partial region from the first region of the first subject recognized by the first recognizer in the image, referring to the second region of the second subject recognized by the second recognizer, and determines the extracted partial region as the subject region.

3. The imaging apparatus according to claim 2, wherein
the second subject is a specific type of subject included in the first subject, and
the controller excludes, from the first region of the first subject recognized by the first recognizer in the image, another partial region having a predetermined correspondence relationship with the second region of the second subject recognized by the second recognizer, and determines the extracted partial region remained after exclusion as the subject region.

4. The imaging apparatus according to claim 2, wherein
the second subject is a different subject related to the first subject, and
the controller narrows the first region of the first subject recognized by the first recognizer to the partial region located within a predetermined range from the second region of the second subject recognized by the second recognizer in the image, and determines the extracted partial region narrowed down as the subject region.

5. The imaging apparatus according to claim 1, further comprising
a user interface that receives a user operation, wherein
the controller receives the user operation setting the second subject via the user interface, and causes the second recognizer to recognize the second region of the set second subject.

6. The imaging apparatus according to claim 5, wherein
the controller
determines the subject region based on the first region of the first subject recognized by the first recognizer without referring to the second region of the second subject when the second subject is not set, and
determines the subject region based on both the first region of the first subject recognized by the first recognizer and the second region of the second subject recognized by the second recognizer when the second subject is set.

7. The imaging apparatus according to claim 1, further comprising
a communication interface that performs data communication with an external information processing device, wherein
the controller causes, via the communication interface, the external information processing device to recognize a region of a subject in the image indicated by the image data, and causes at least one of the first recognizer or the second recognizer to acquire the recognized region of the subject.

8. An imaging apparatus comprising:
an image sensor that captures a subject image to generate image data;
a user interface that receives a user operation;
a controller that controls image recognition processing for a first subject on the image data generated by the image sensor in response to the user operation received via the user interface,
the controller
receives the user operation setting a second subject included in the first subject or different from the first subject via the user interface; and
controls the image recognition processing based on the second subject set via the user interface to determine a subject region of a recognition result in the image data.
